(19) United States
(12) Patent Application Publication
(10) Pub. No.: US 2004/0148158 A1
(43) Pub. Date: Jul. 29, 2004

(54) Information display control device and recording media that stores information display control programs

(75) Inventor: Yuichi Kobayashi, Tokyo (JP)

Correspondence Address: HOGAN & HARTSON L.L.P., 500 S. GRAND AVENUE, SUITE 1900, LOS ANGELES, CA, 90071-2611, US

(73) Assignee: CASIO COMPUTER CO., LTD.

(21) Appl. No.: 10/745,162

(22) Filed: Dec. 23, 2003

(30) Foreign Application Priority Data
Dec. 27, 2002 (JP) 2002-382132

(51) Int. Cl. G10L 19/00; G10L 21/00

(52) U.S. Cl. 704/201

(57) ABSTRACT

An information display control device includes a dictionary data base that stores entry words and explanatory information correlated with each of the entry words. When an entry word is designated, explanatory information corresponding to the designated entry word is displayed. The information display control device extracts from the dictionary data base matching words that match parts of character strings included in the explanatory information corresponding to the designated entry word, and identifiably displays the extracted matching entry words. Further, the dictionary data base may include a plurality of different dictionary data bases. The information display control device extracts from the character strings of the displayed explanatory information character strings that match any of the entry words stored in any one of the dictionary data bases, and displays the extracted matching character strings in display formats that are different for each of the different dictionary data bases.

### BACKGROUND OF THE INVENTION

1. Field of the Invention

The present invention relates to an information display control device and recording media with programs recorded for searching explanatory information corresponding to designated entry words.

2. Description of the Related Arts

Information display control devices called electronic dictionaries have been known for some time. An electronic dictionary may be provided with a plurality of electronic dictionary data such as a Japanese language dictionary, English-Japanese dictionary, Japanese-English dictionary, English language dictionary, and encyclopedia. The electronic dictionary is typically equipped with a jump function. By utilizing the jump function provided in the electronic dictionary, a character string within explanatory information for a word in, for example, a Japanese language dictionary can be designated, and the character string can be used as an entry word to display explanatory information for the entry word in the same Japanese language dictionary or in other dictionaries, such as the Japanese-English dictionary, or the encyclopedia.

The jump function (hereinafter called “jump” when appropriate) provided in the electronic dictionaries refers to a function in which, when explanatory information for an entry word is displayed, and a character string of part of the explanatory information is designated, the designated character string is used as a search word to perform further searches.

Furthermore, as one of the jump functions, an electronic dictionary having a plurality of dictionaries may be provided with a function to set a jump destination dictionary among the plurality of dictionaries when making a jump to another dictionary while using one dictionary

However, according to the conventional jump function described above, due to the fact that a search for an entry word in a dictionary is performed after a character string in the explanatory information being displayed is designated, the entry word that corresponds to the designated character string does not necessarily exist in the dictionary. As a result, a user would sometimes designate a word or a term whose explanation does not exist in the electronic dictionary data and instruct a jump to the word or the term, which leads to a poor ease of use.

### SUMMARY OF THE INVENTION

The present invention has been conceived in view of the circumstances of the related art described above, and provides an information display device that can readily and appropriately display further explanatory information regarding explanatory information for entry words in information display control devices such as electronic dictionaries.

The present invention relates to an information display control device having a database that stores entry words and explanatory information correlated with each of the entry words. When an entry word is designated, explanatory information corresponding to the designated entry word is displayed. The information display control device extracts matching words from the database that match parts of character strings included in the explanatory information corresponding to the designated entry word, and displays the explanatory information corresponding to the designated entry word in a manner that the extracted matching entry words are identifiably displayed.

In accordance with an embodiment of the present invention, an information display control device includes first and second information storage units, each storing entry words, explanatory information corresponding to each of the entry words and explanation of words included in the explanatory information, wherein the entry words, the explanatory information and the words are correlated with one another. When explanatory information corresponding to a designated entry word is searched from among the first information storage unit and displayed, the information display control device performs a display indicating that explanation of at least one word included in the explanatory information can be found in the first information storage unit, when it is determined that the explanation of the word included in the explanatory information is stored in the first information storage unit. Furthermore, information display control device performs a display indicating that explanation of the at least one word included in the explanatory information can be found in the second information storage unit, when it is determined that the explanation of the word included in the explanatory information is stored in the second information storage unit.

In accordance with another embodiment of the present invention, an information display control device includes a plurality of information storage units, each storing entry words and explanatory information for each of the entry words. When the explanatory information includes character strings that match any of the entry words stored in any one of the plurality of information storage units, the explanatory information include entry word present information correlated with the matched character strings. The information display control device includes a designation unit that designates one of the plurality of information storage units, and an entry word designation unit that designates an entry word. When one of the information storage units is designated, and explanatory information corresponding to the entry word designated by the entry word designation unit is searched and displayed, the information display control device displays the explanatory information for the designated entry word such that those of character strings in the explanatory information correlated with the entry word present information are identifiably displayed based on the entry word present information corresponding to the explanatory information searched. Accordingly, further explanatory information for explanatory information for a designated entry word can be readily and appropriately searched from among a plurality of information storage units and displayed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 schematically shows a perspective view of one example of a portable electronic dictionary in accordance with an embodiment of the present invention.

FIG. 2 shows an example of a functional configuration of a portable electronic dictionary in accordance with a first embodiment of the present invention.

FIG. 3 shows an example of an accumulation format in a net dictionary data base (DB).

FIG. 4 shows an example of an accumulation format in an English dictionary data base (DB).

FIG. 5 shows an example of an extracted character string storage region.

FIG. 6 shows an example of a selected character string storage region.

FIG. 7 shows an example of an accumulation format in a net dictionary entry word list.

FIG. 8 shows a flowchart of an operation of a portable electronic dictionary relating to an execution of a dictionary search with jump destination display processing.

FIG. 9A-FIG. 9E show an example of screen transition displayed on a display section in accordance with the first embodiment.

FIG. 10 shows a flowchart of an operation of a portable electronic dictionary relating to an execution of a jump destination display processing.

FIG. 11 shows a modified example of a search result display screen.

FIG. 12 is a flowchart of an operation of a portable electronic dictionary relating to an execution of a net dictionary entry word acquisition processing.

FIG. 13 and FIG. 13B show an example of the structure of a flash ROM and an example of the structure of a RAM in accordance with a second embodiment of the present invention, respectively.

FIG. 14 shows an example of an accumulation format in a Japanese-English dictionary DB.

FIG. 15 shows a flowchart of an operation of a portable electronic dictionary in relation to an execution of a dictionary search with recommendation degree display processing.

FIG. 16A-FIG. 16C show an example of screen transition displayed on a display section in accordance with the second embodiment.

FIG. 17 shows a flowchart of an operation of a portable electronic dictionary in relation to an execution of a jump destination recommendation degree display processing.

FIG. 18A-FIG. 18C show an example of screen transition displayed on a display section in accordance with the second embodiment.

### PREFERRED EMBODIMENTS OF THE PRESENT INVENTION

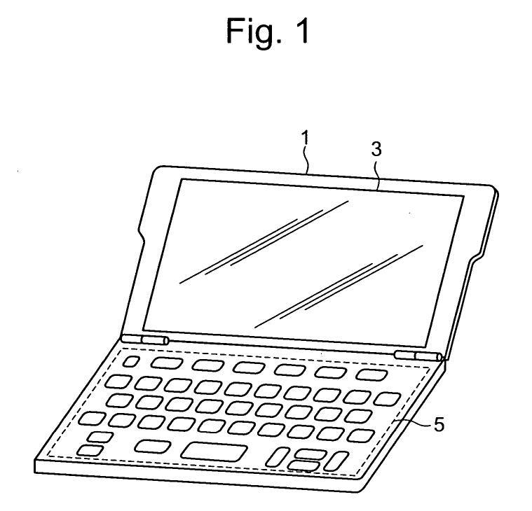

Referring to FIGS. 1-18, information display control devices in accordance with various embodiments of the present invention are described in detail below. In these embodiments, the present invention is applied to folding-type portable electronic dictionaries.

Portable electronic dictionaries have various types of built-in electronic dictionary data (dictionary databases), such as a Japanese language dictionary, English-Japanese dictionary, Japanese-English dictionary, thesaurus, and dictionary of proverbs. The electronic dictionary data stored may contain character data, picture data, moving picture data and/or voice data corresponding to each entry word to explain the entry word. By selecting the type of dictionary and inputting a search word, a user can have the explanation of the search word displayed. Further, by using the jump function, the user can also have explanation of words included in the explanation of the search word displayed. In the following, a description will be made as to a situation in which three types of electronic dictionary data, namely an English language dictionary, English-Japanese dictionary and Japanese-English dictionary, are built in a portable electronic dictionary.

FIG. 1 schematically shows a perspective view of an example of a portable electronic dictionary 1, which is one type of information display control device. As indicated in the drawing, the portable electronic dictionary 1 comprises a display 3 and a key group of various keys 5. Each key that constitutes the key group 5 is assigned a unique function, and the user presses the keys to operate the portable electronic dictionary 1.

More specifically, the key group 5 may include character input keys, dictionary type selection keys, a key to jump to a designated word, a key to display a list of usage examples of the designated word, etc. Further, by switching an input mode, KANA (Japanese characters) input and English alphabet input through character input keys can be switched from one to the other.

### First Embodiment

First, a description will be made as to the portable electronic dictionary 1 in accordance with a first embodiment of the present invention, which is an information display control device.

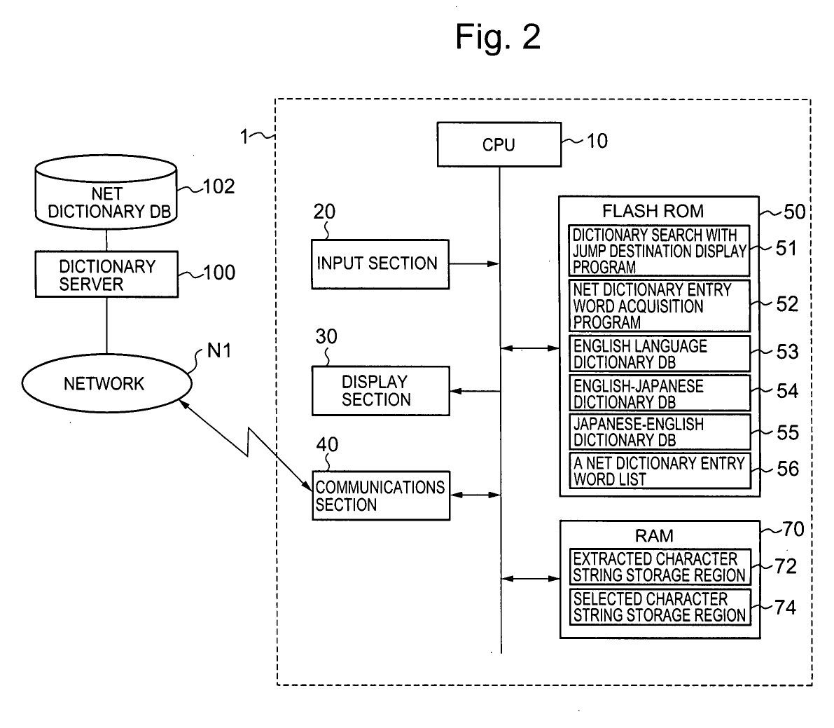

FIG. 2 is a diagram of an example of a functional configuration of the portable electronic dictionary 1. As indicated in the drawing, the portable electronic dictionary 1 comprises function sections consisting of a CPU 10, an input section 20, a display section 30, a communications section 40, a flash ROM 50 and a RAM 70.

The CPU 10 executes processings based on predetermined programs in response to instructions inputted, and transfers instructions and data to various functional sections, thereby comprehensively controlling the portable electronic dictionary 1. More specifically, for example, the CPU 10 reads a program stored in the flash ROM 50 in response to a depression signal inputted through the input section 20, and executes a processing according to the program. The CPU 10 then stores the processing result in the RAM 70, while at the same time appropriately outputting to the display section 30 display signals for displaying the processing result such that the corresponding display information is displayed.

The input section 20 is an input device provided with a group of keys required for KANA or alphabet character input and function selections, and outputs to the CPU 10 depression signals generated by depressing the keys. Key input through the input section 20 realizes input units, such as search word inputs, dictionary type selections, search execution instructions, jump execution instructions and mode switch instructions. The input section 20 is equivalent to the key group of various keys 5 in FIG. 1.

The display section 30 serves to display various types of screens based on the display signals inputted from the CPU 10 and comprises an LCD (liquid crystal display). The display section 30 is equivalent to the display 3 in FIG. 1.

The communications section 40 comprises communication devices for sending and receiving predetermined information to and from other devices (e.g., a dictionary server 100) connected via a network N1. A network such as LAN, WAN or the Internet is applicable to the network N1, and the CPU 10 performs controls for communications with external equipment via the communications section 40, as well as a communication line such as a telephone line, ISDN line, wireless communications line, dedicated line or a CATV line.

The dictionary server 100 publishes in a searchable/displayable manner dictionary data accumulated in a net dictionary database 102 (hereinafter a database is called a “DB”), which is controlled by the dictionary server 100. More specifically, the dictionary server 100 searches for designated entry words in the net dictionary DB 102 in response to dictionary data search requests sent from the portable electronic dictionary 1, sends to the portable electronic dictionary 1 the explanatory information that corresponds to the entry words, and thereby publishes and provides the net dictionary DB 102.

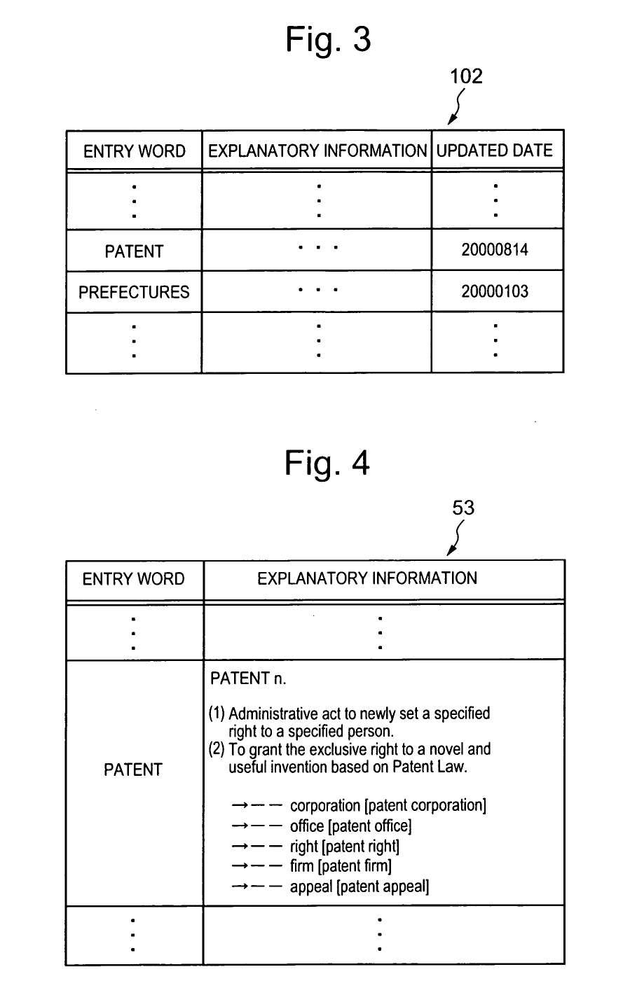

FIG. 3 is an example of the accumulation format in the net dictionary DB 102. As shown in the drawing, in the net dictionary DB 102, dictionary data are accumulated in a manner that entry words, explanatory information and update dates are correlated to each other. The net dictionary DB 102 is updated whenever a new word is added, for example, and the corresponding update date is updated appropriately when the dictionary data is updated. The explanatory information stores related picture data and voice data appropriately correlated, in addition to character data for explaining entry words.

In response to an entry word acquisition request from the portable electronic dictionary 1, the dictionary server 100 sends to the portable electronic dictionary 1 the entry word stored in the net dictionary DB 102. More specifically, the portable electronic dictionary 1 retains the date the entry word was last downloaded, and sends the entry word acquisition request along with the date to the dictionary server 100. The dictionary server 100 refers to the update date stored in the net dictionary DB 102 and sends to the portable electronic dictionary 1 the entry word in the dictionary data that was updated on or after the date received along with the entry word acquisition request.

The flash ROM 50 stores electrically written information in a nonvolatile manner, even when the power source is shut off. The flash ROM 50 stores initial programs for performing various initial settings, hardware inspections, or loading of required programs. By executing the initial programs when the power source is turned on in the portable electronic dictionary 1, the CPU 10 sets the operational environment for the portable electronic dictionary 1.

In addition, the flash ROM 50 stores various types of processing programs related to the operations of the portable electronic dictionary 1 and programs for realizing various functions provided in the portable electronic dictionary 1, as well as a dictionary search with jump destination display program 51, a net dictionary entry word acquisition program 52, an English language dictionary DB 53, an English-Japanese dictionary DB 54, a Japanese-English dictionary DB 55, and a net dictionary entry word list 56.

The CPU 10 executes a dictionary search with jump destination display processing according to the dictionary search with jump destination display program 51 stored in the flash ROM 50.

More specifically, for example, the CPU 10 first searches for an entry word from among entry words stored in a dictionary DB designated (hereinafter called a “designated dictionary DB”) that matches a designated search word in response to a search instruction input, and displays the corresponding explanatory information on the display section 30.

FIG. 4 is an example of an accumulation format in the English language dictionary DB 53. As shown in the drawing, dictionary data consisting of entry words correlated to explanatory information, which are character data that explain the corresponding entry words, are accumulated in the English language dictionary DB 53. Similarly, dictionary data consisting of entry words correlated to explanatory information are accumulated in the English-Japanese dictionary DB 54 and the Japanese-English dictionary DB 55. Hereinafter, the English language dictionary DB 53, the English-Japanese dictionary DB 54, the Japanese-English dictionary DB 55, and the net dictionary DB 102 are collectively called “dictionary DB.”

Next, in response to a jump execution instruction, the CPU 10 then extracts character strings from among character strings in the explanatory information displayed at this point on the display section 30 that match with any of the entry words stored in various dictionary DBs (hereinafter called a “registered entry word” when appropriate). More specifically, the CPU 10 scans character strings in the explanatory information sequentially from the beginning; extracts words through a search based on the longest matching method; and, if an entry word that matches an extracted word is stored in any of the dictionary DBs, stores the character string of the word (hereinafter called a “matching character string” when appropriate) in an extracted character string storage region 72 to be retained.

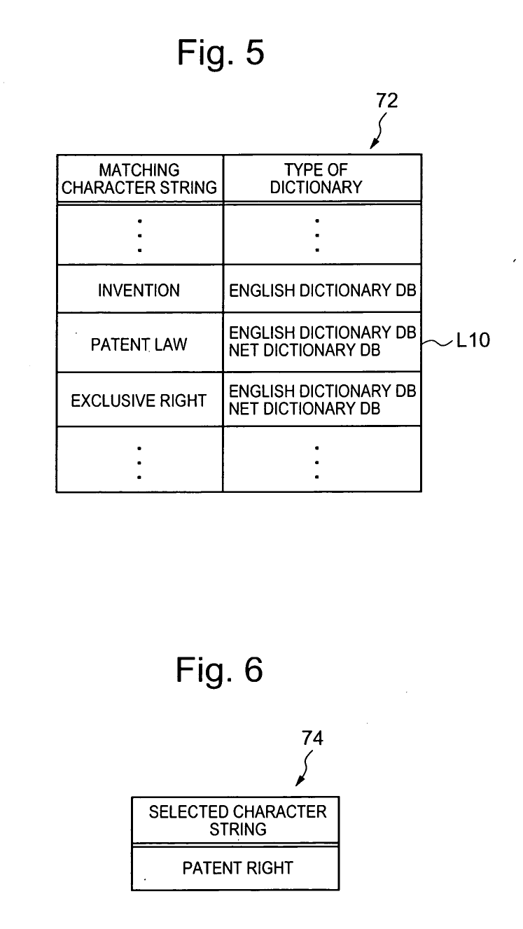

FIG. 5 is an example of the extracted character string storage region 72. As shown in the drawing, the extracted character string storage region 72 stores matching character strings correlated to the types of dictionaries in which the corresponding registered entry words are stored. For example, a record L10 indicates that entry words that match with an extracted matching character string “patent law” are stored in the English language dictionary DB 53 and the net dictionary DB 102.

Then the CPU 10 displays the extracted matching character strings in display modes that differ depending on the type of dictionary to which a jump can be made. The matching character strings are selectable on the display screen. FIG. 6 shows an example of a selected character string storage region 74. The CPU 10 updates as necessary the selected character string storage region 74 in relation to the matching character string currently selected.

Then, in response to a jump defining instruction to the matching character string selected, the CPU 10 sets the corresponding jump destination dictionary DB as the designated dictionary DB and the corresponding matching character string as the entry word data, and reads and displays the corresponding explanatory information.

Also, the CPU 10 executes a net dictionary entry word acquisition processing according to the net dictionary entry word acquisition program 52.

More specifically, in response to an update instruction for a net dictionary entry word, the CPU 10 connects to the dictionary server 100 via the communications section 40 and the network N1 and downloads the entry words stored in the net dictionary DB 102.

More specifically, the CPU 10 sends an entry word acquisition request to the dictionary server 100. At this time, the CPU 10 sends an update date stored in the net dictionary entry word list 56 along with the entry word acquisition request.

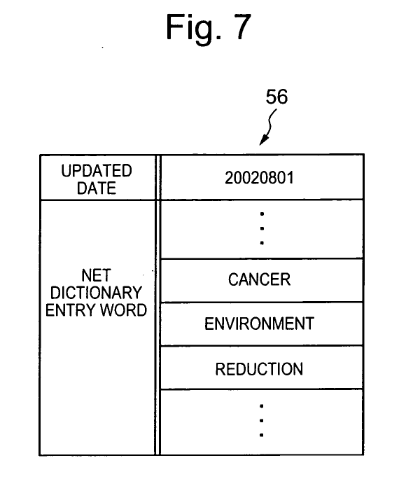

FIG. 7 shows an example of the accumulation format in the net dictionary entry word list 56. As shown in the drawing, the net dictionary entry word list 56 stores the update date, which is the latest date entry words in the net dictionary were downloaded, and a list of net dictionary entry words downloaded. For example, the list of net dictionary entry words in FIG. 7 indicates that it was updated on Aug. 1, 2002.

The CPU 10 additionally monitors the time elapsed since the net dictionary entry word list 56 was last updated; and when it is determined that a predetermined entry word update timing (e.g., one month has elapsed since the last update) has arrived, the CPU 10 automatically sends, when a connection with the dictionary server 100 is established after this determination, to the dictionary server 100 the entry word acquisition request and the update date stored in the net dictionary entry word list 56, downloads the entry words stored in the net dictionary DB 102, and updates the net dictionary entry word list 56.

The RAM 70 is provided with memory regions that temporarily store various programs executed by the CPU 10 and data related to the execution of such programs. In particular, the RAM 70 is provided with the extracted character string storage region 72 and the selected character string storage region 74.

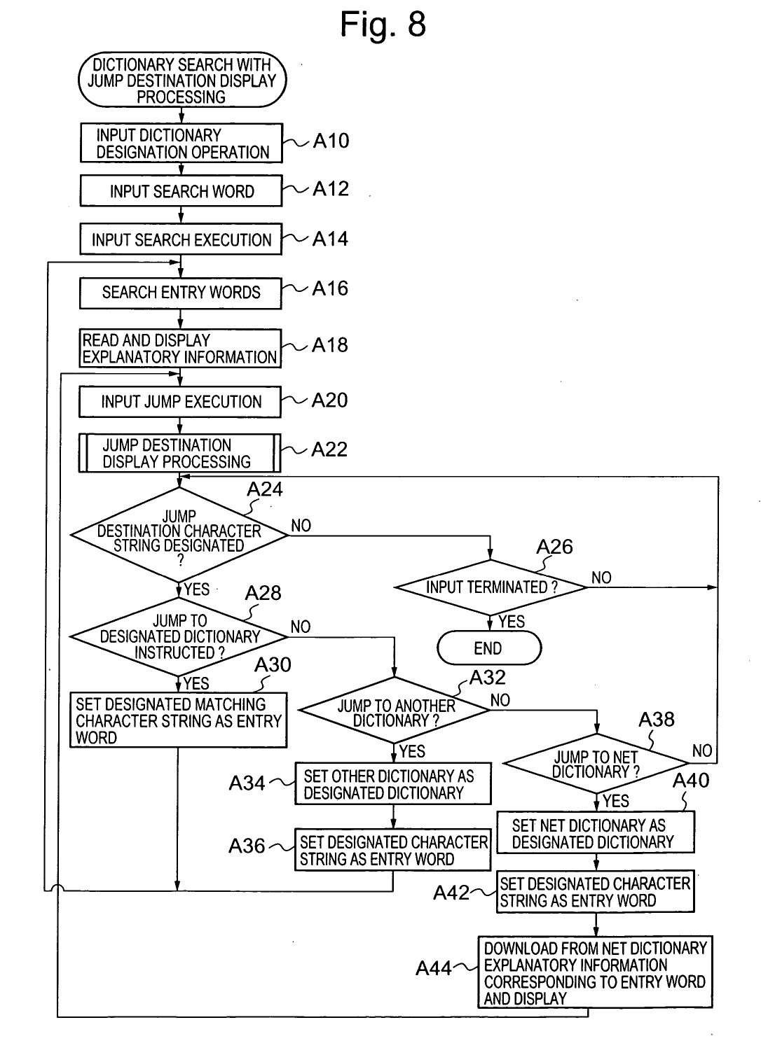

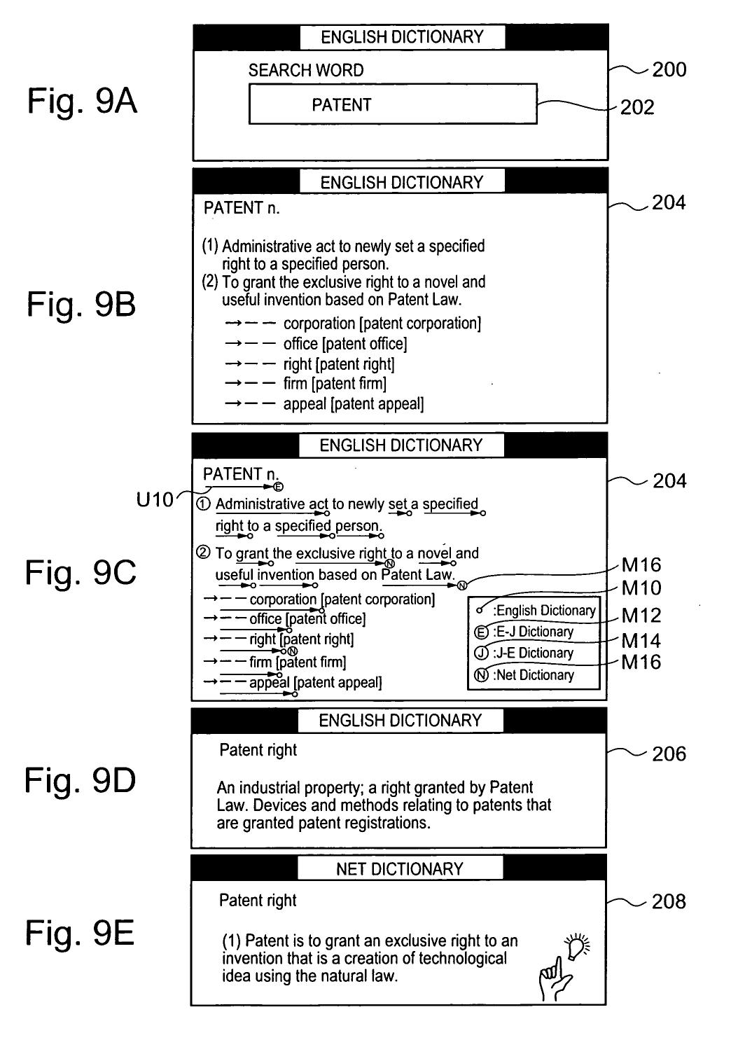

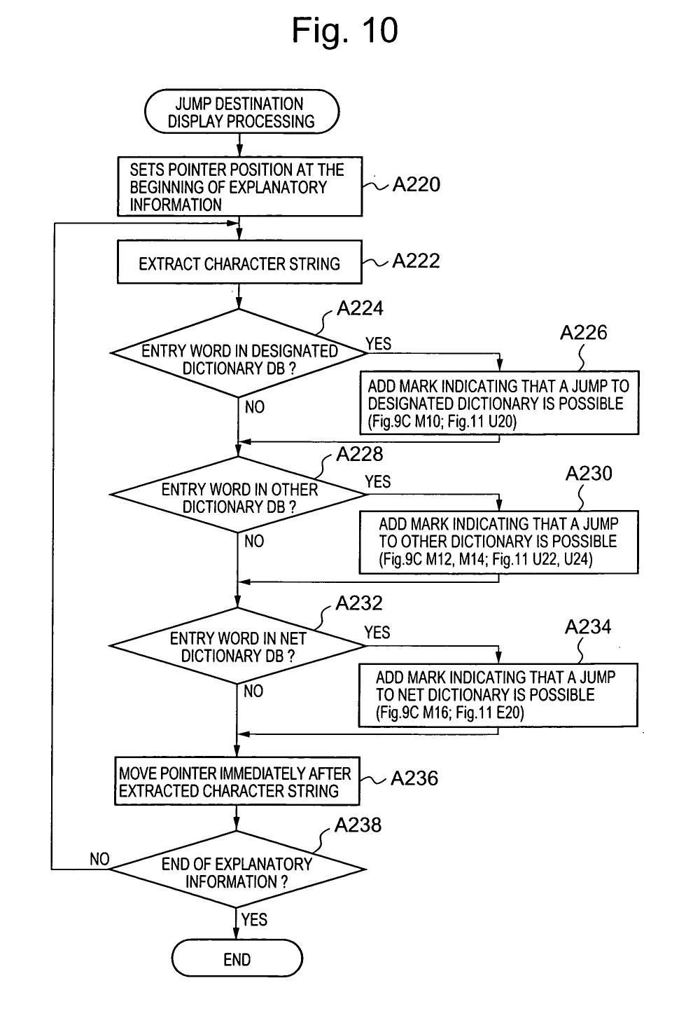

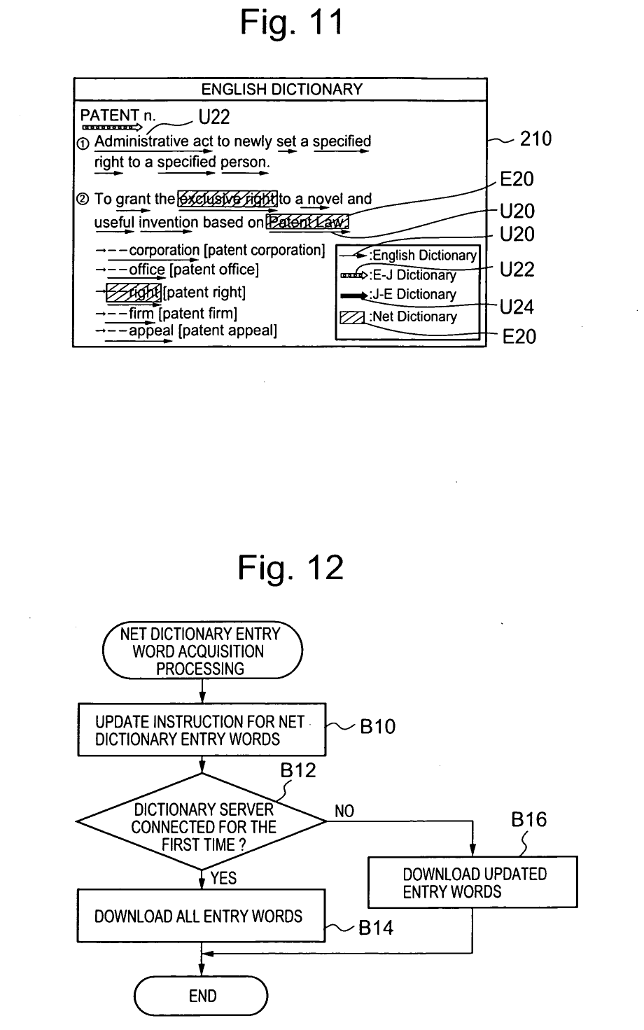

Next, referring to FIGS. 8-12, the operations of the portable electronic dictionary 1 in accordance with the first embodiment of the present invention is described. FIGS. 8, 10 and 12 indicate the operational flow of the portable electronic dictionary 1, FIGS. 9A-9E show an example of screen transition displayed on the display section 30, and FIG. 11 indicates an example of a display screen.

FIG. 8 is a flowchart of the operation of the portable electronic dictionary 1 relating to the execution of the dictionary search with jump destination display processing. As shown in the drawing, when a dictionary designation operation is inputted (step A10), the CPU 10 displays on the display section 30 a search word input screen; the CPU 10 stands by until a search word is inputted (step A12) and a search execution is instructed (step A14).

FIG. 9A is an example of a search word input screen 200. The search word input screen 200 shown in the drawing is an example of a screen that is displayed when the English language dictionary is designated, and a search word “patent” is inputted in a search word input box 202.

In response to a search execution instruction, the CPU 10 first sets the designated search word as the entry word and searches for the entry word from among entry words stored in the designated dictionary DB that was designated in step A10 (step A16). Next, the CPU 10 reads explanatory information that corresponds to the entry word searched and displays it on the display section 30 (step A18).

FIG. 9B shows an example of a search result display screen 204 that is displayed at this stage on the display section 30. As shown in the drawing, the explanatory information that corresponds to the entry word “patent” is displayed on a search result display screen 204.

When a jump execution instruction is inputted (step A20), the CPU 10 executes the jump destination display processing (step A22).

FIG. 10 is a flowchart of the operation of the portable electronic dictionary 1 relating to the execution of the jump destination display processing. As shown in the drawing, the CPU 10 first sets the pointer position at the beginning of the explanatory information (step A220). The pointer specifies the beginning character of a character string that is read from the explanatory information. Next, the CPU 10 sequentially scans characters that are arranged from the pointer position through a search based on the longest matching method and extracts a word (step A222).

If the extracted character string matches with an entry word stored in the designated dictionary DB (e.g., the English language dictionary DB 53) (step A224: YES), the CPU 10 identifiably displays the matching entry word by adding to the matching entry word a mark indicating that a jump to the dictionary is possible (step A226). The identifiable display is not limited to an identifiable display using a mark and may be an identifiable display, for example, based on character color or character font of the matching entry word or on the background color, or an identifiable display based on underlining. In addition, the CPU 10 correlates to the matching entry word a dictionary type that indicates the designated dictionary DB and stores the information in the extracted character string storage region 72.

For example, as shown in FIG. 9C, the entry word “patent law” is identifiably displayed with an underline with arrow (U10), which indicates that a jump destination exists, and a mark M10, which indicates that the jump destination is the English language dictionary, is displayed. Another example is shown in FIG. 11, where the entry word “patent law” is identifiably displayed with an underline with arrow U20 in a certain line type, which indicates that a jump destination exists and that the jump destination is the Japanese language dictionary.

If the character string matches with an entry word stored in another dictionary DB (e.g., the English-Japanese dictionary DB 54 or the Japanese-English dictionary DB 55) (step A228: YES), the CPU 10 identifiably displays the matching entry word by adding to the matching entry word a mark indicating that a jump to the dictionary is possible (step A230). The identifiable display is not limited to an identifiable display using a mark and may be an identifiable display, for example, based on character color or character font of the matching entry word or on the background color, or an identifiable display based on underlining. In addition, the CPU 10 correlates to the matching entry word a dictionary type that indicates the corresponding dictionary DB and stores the information in the extracted character string storage region 72.

For example, as shown in FIG. 9C, the character string “patent” is identifiably displayed with the underline with arrow U10, which indicates that a jump destination exists, and a mark M12, which indicates that the jump destination is the English-Japanese dictionary, is displayed. If the jump destination were the Japanese-English dictionary, the fact that the entry word has a jump destination would be identifiably displayed with the underline with arrow (U10), and a mark (M14) to indicate that the jump destination is the Japanese-English dictionary would be displayed. Another example is shown in FIG. 11, where “Patent” is identifiably displayed with an underline with arrow U22 in a certain line type, which indicates that a jump destination exists and that the jump destination is the English-Japanese dictionary. If the jump destination were the Japanese-English dictionary, the fact that the character string has a jump destination would be identifiably displayed with an underline with arrow (U24) in the corresponding line type.

If the character string matches with an entry word stored in the net dictionary DB 102, in other words, if the character string matches with an entry word stored in the net dictionary entry word list 56 (step A232: YES), the CPU 10 identifiably displays the matching entry word by adding to the matching entry word a mark indicating that a jump to the dictionary is possible (step A234). The identifiable display is not limited to an identifiable display using a mark and may be an identifiable display, for example, based on character color or character font of the matching entry word or on the background color, or an identifiable display based on underlining. In addition, the CPU 10 correlates to the matching entry word a dictionary type that indicates the net dictionary DB 102 and stores the information in the extracted character string storage region 72.

For example, as shown in FIG. 9C, the entry word “patent law” is identifiably displayed with the underline with arrow (U10), which indicates that a jump destination exists, and a mark M16, which indicates that the jump destination is the net dictionary, is displayed. Another example is shown in FIG. 11, where the entry word “patent law” is identifiably displayed with a background color in a character string display area E20 that is different from other areas, which indicates that a jump destination exists and that a jump whose jump destination is the net dictionary can be made.

The CPU 10 then moves the pointer to immediately after the matching entry word (step A236); if the pointer position is not at the end of the explanatory information (step A238: NO), the CPU 10 returns to step A222 and repeats the processing. If the pointer position is at the end of the explanatory information (step A238: YES), the CPU 10 terminates the processing and transitions to step A24 in FIG. 8.

The CPU 10 accepts an input of a jump destination character string designation operation (step A24) and monitors an input of a termination operation (step A26); if the termination operation is inputted, the CPU 10 terminates the processing.

If the jump destination character string designation operation is inputted (step A24: YES) and a jump to the designated dictionary is instructed (step A28: YES), the CPU 10 refers to the selected character string storage region 74, sets the designated matching character string as the entry word (step A30), returns to step A16 to repeat the processing, and searches for and displays the corresponding explanatory information.

If a jump to another dictionary is instructed (step A32: YES), the CPU 10 sets the other dictionary as the designated dictionary (step A34) and refers to the selected character string storage region 74 to set the designated matching character string as the entry word (step A36). The CPU 10 then returns to step A16 to repeat the processing and searches for and displays the corresponding explanatory information.

If a jump to the net dictionary is instructed (step A38: YES), the CPU 10 sets the net dictionary as the designated dictionary (step A40) and refers to the selected character string storage region 74 to set the designated matching character string as the entry word (step A42). The CPU 10 then connects to the dictionary server 100 via the communications section 40 and the network N1 to send the entry word, downloads from the net dictionary DB 102 the corresponding explanatory information, and displays the explanatory information (step A44).

For example, when “——right” is selected in the search result display screen 204 shown in FIG. 9C, a screen that urges an input for selecting a jump destination dictionary type is displayed, so that either the English language dictionary or the net dictionary can be selected. If a jump to the English language dictionary is instructed, a search result display screen 206 shown in FIG. 9D, for example, is displayed and explanatory information that corresponds to the entry word “patent right” stored in the English language dictionary DB 53 is displayed. On the other hand, if a jump to the net dictionary is instructed, a search result display screen 208 shown in FIG. 9E is displayed and explanatory information that corresponds to the entry word “patent right” stored in the net dictionary DB 102 is displayed.

FIG. 12 is a flowchart of the operation of the portable electronic dictionary 1 relating to the execution of the net dictionary entry word acquisition processing. As shown in the drawing, when an update instruction for net dictionary entry words is inputted through the input section 20 (step B10), if this is the first time the CPU 10 connects to the dictionary server 100 (step B12: YES), the CPU 10 sends an entry word acquisition request to the dictionary server 100. The CPU 10 downloads all entry words stored in the net dictionary DB 102, and updates the net dictionary entry words and the update date to the current date in the net dictionary entry word list 56 (step B14).

In response to the second and subsequent update instructions (step B12: NO), the CPU 10 sends to the dictionary server 100 the update date stored in the net dictionary entry word list 56. The CPU 10 downloads entry words that correspond to dictionary data that were updated on or after the last update of the entry word list of the net dictionary to update the net dictionary entry words and the update date to the current date in the net dictionary entry word list 56 (step B16), and terminates the processing.

As described above, according to the first embodiment, from among character strings included in explanatory information that is displayed as a result of inputting a search word and instructing a search execution, those of the character strings that match registered entry words can be displayed in different display modes depending on the type of the jump destination dictionary.

According to the first embodiment described above, from among character strings in the explanatory information displayed, those of the character strings that match the registered entry words are extracted. However, marks that identify the corresponding dictionary types can be respectively correlated to matching character strings included in the explanatory information and stored, such that the matching character strings can be displayed in display modes different from other character strings based on the mark information when the explanatory information is displayed.

### Second Embodiment

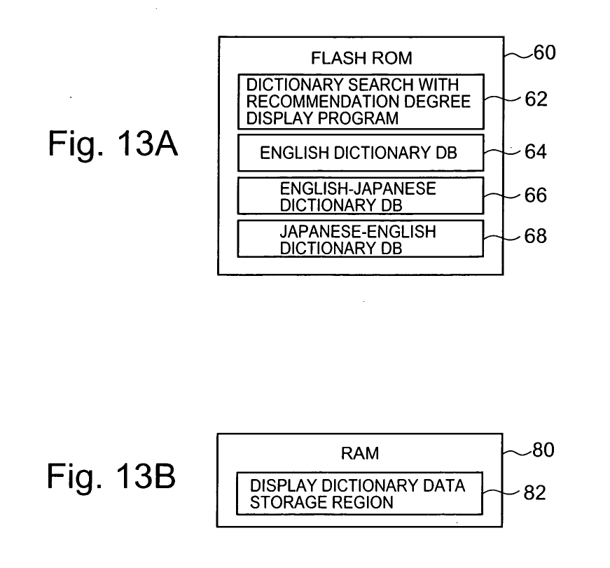

Next, a portable electronic dictionary in accordance with a second embodiment of the present invention will be described. The configuration of the portable electronic dictionary according to the second embodiment is the same as the configuration of the portable electronic dictionary 1 in FIG. 2 of the first embodiment, except that the flash ROM 50 is replaced with a flash ROM 60 shown in FIG. 13A, and the RAM 70 with a RAM 80 shown in FIG. 13B; otherwise, identical components are assigned same numbers and their descriptions are omitted.

First, referring to FIGS. 13A and 13B, the configurations of the flash ROM 60 and the RAM 80 according to the second embodiment of the present invention will be described. FIG. 13A shows the configuration of the flash ROM 60, while FIG. 13B shows the configuration of the RAM 80. As shown in FIG. 13A, the flash ROM 60 stores, to realize the second embodiment, a dictionary search with recommendation degree display program 62, a English language dictionary DB 64, an English-Japanese dictionary 66, and a Japanese-English dictionary DB 68. As shown in FIG. 13B, the RAM 80 is provided with a display dictionary data storage region 82 for retaining dictionary data to be displayed on a display section 30.

A CPU 10 executes a dictionary search with recommendation degree display processing according to the dictionary search with recommendation degree display program 62, which is stored in the flash ROM 60.

More specifically, the CPU 10 first searches for an entry word from among entry words stored in a designated dictionary DB that matches a designated search word in response to a search instruction input, and displays the corresponding explanatory information on the display section 30.

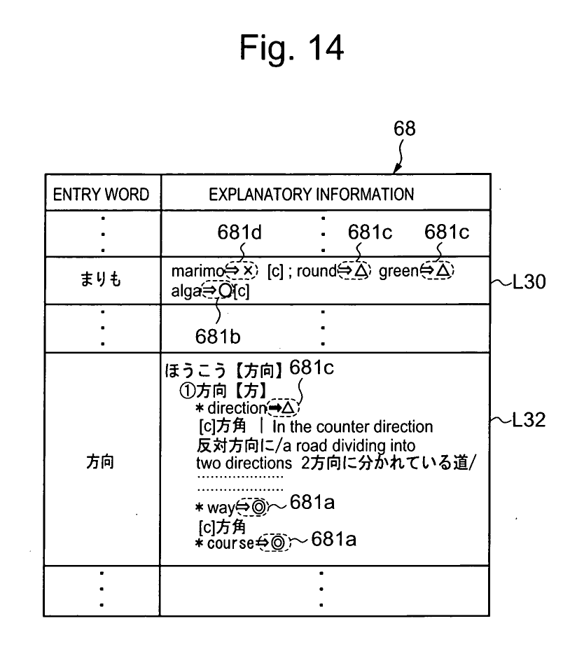

FIG. 14 is an example of the accumulation format in the Japanese-English dictionary DB 68. As shown in the drawing, dictionary data consisting of entry words correlated to explanatory information are accumulated in the Japanese-English dictionary DB 68. The explanatory information includes recommendation degree information in order to display a degree of jump recommendation for each matching entry word included in the explanatory information.

More specifically, in dictionary data indicated by a record L30, for example, the explanatory information includes English words “marimo,” “round,” “green” and “alga,” as well as recommendation degree information 681d “ [symbol] x” that corresponds to “marimo,” recommendation degree information 681c “ [symbol] Δ” that corresponds to “round,” the recommendation degree information 681c “ [symbol] Δ” that corresponds to “green,” and recommendation degree information 681b “ [symbol] Δ” that corresponds to “alga.”Furthermore, in dictionary data indicated by a record L32, the explanatory information includes English words “direction,” “way” and “course,” as well as the recommendation degree information 681c “ [symbol] Δ” that corresponds to “direction,” recommendation degree information 681a “ [symbol] ⊚” that corresponds to “way,” and the recommendation degree information 681a “ [symbol] ⊚” that corresponds to “course.”

The recommendation degree information indicates that the degree of recommendation increases sequentially, for example, in the order of the recommendation degree information 681d “ [symbol] x,” the recommendation degree information 681c “ [symbol] Δ,” the recommendation degree information 681b “◯,” and the recommendation degree information 681a “ [symbol] ⊚.” The recommendation degree information 681d “ [symbol] x” in particular indicates that there is no jump destination or explanatory information for the corresponding character string. Similarly, dictionary data consisting of entry words correlated to explanatory information that include recommendation degree information are accumulated in the Japanese language dictionary DB 64 and the English-Japanese dictionary DB 66.

The recommendation degree information is set in advance based on the amount of data in the corresponding explanatory information, the number of example sentences and/or phrases included in the corresponding explanatory information, and the meaning and content of the explanatory information.

The amount of data in the explanatory information refers, for example, to the number of characters in the corresponding explanatory information. To define the recommendation degree information based on the amount of data in the explanatory information, the recommendation degree information 681d “ [symbol] x” is correlated to the corresponding word if the number of characters in its explanatory information is “0,” the recommendation degree information 681c “ [symbol] Δ” if the number of characters is 1-149 characters, the recommendation degree information 681b “ [symbol] ◯” if the number of characters is 150 characters to 299 characters, and the recommendation degree information 681a “ [symbol] ⊚” if the number of characters is 300 characters or more, for example.

The number of example sentences and/or phrases in the explanatory information refers to the number of example sentences and/or phrases that use the word of the entry word and that are included in the explanatory information for the entry word “direction” in FIG. 14, for example, such as “in the counter direction” and “a road dividing into two directions.” To define the recommendation degree information based on the number of example sentences and/or phrases in the explanatory information, the recommendation degree information 681d “ [symbol] x” is correlated to the corresponding word if the number of example sentences and/or phrases included in its explanatory information is “0,” the recommendation degree information 681c “ [symbol] Δ” if the number of example sentences and/or phrases is “1” to “4,” the recommendation degree information 681b “ [symbol] ◯” if the number of example sentences and/or phrases is “5” to “9,” and the recommendation degree information 681a “ [symbol] ⊚” if the number of example sentences and/or phrases is “10” or more, for example, and stored.

Alternatively, the recommendation degree information can be defined according to the meaning and content of the corresponding explanatory information. To define the recommendation degree information based on the meaning and content of the explanatory information, in the explanatory information for a Japanese entry word (for example, “ [symbol] ” which may typically correspond to an English word “marimo”) in FIG. 14, for example, the recommendation degree information 681b “ [symbol] ◯” is set and stored for “alga,” the recommendation degree information 681c “ [symbol] Δ” is set and stored for “round” and “green,” and the recommendation degree information 681d “ [symbol] x” is set and stored for “marimo,” according to the meaning and content of the Japanese entry word.

When displaying on the display section 30 the explanatory information corresponding to the entry word designated as the search word, the CPU 10 displays on the display section 30 the words to which recommendation degree information is correlated in display modes different from other character strings. In addition, the CPU 10 creates explanatory information for display purposes, in which the recommendation degree information included in the explanatory information is deleted, and updates the display dictionary data storage region 82, and stores the explanatory information for display purposes.

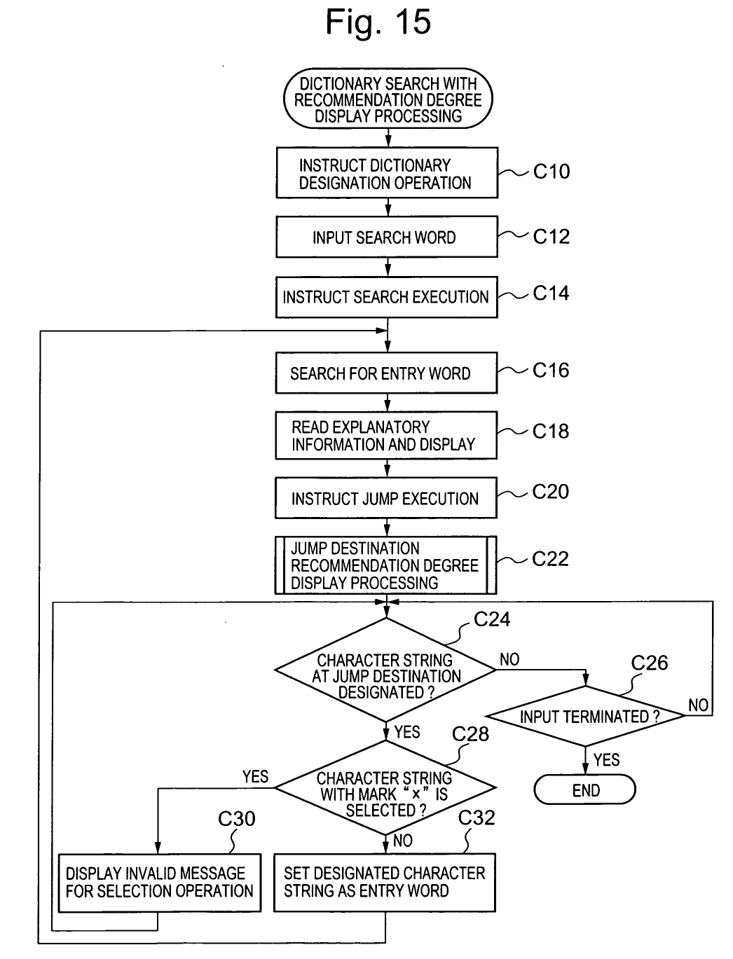

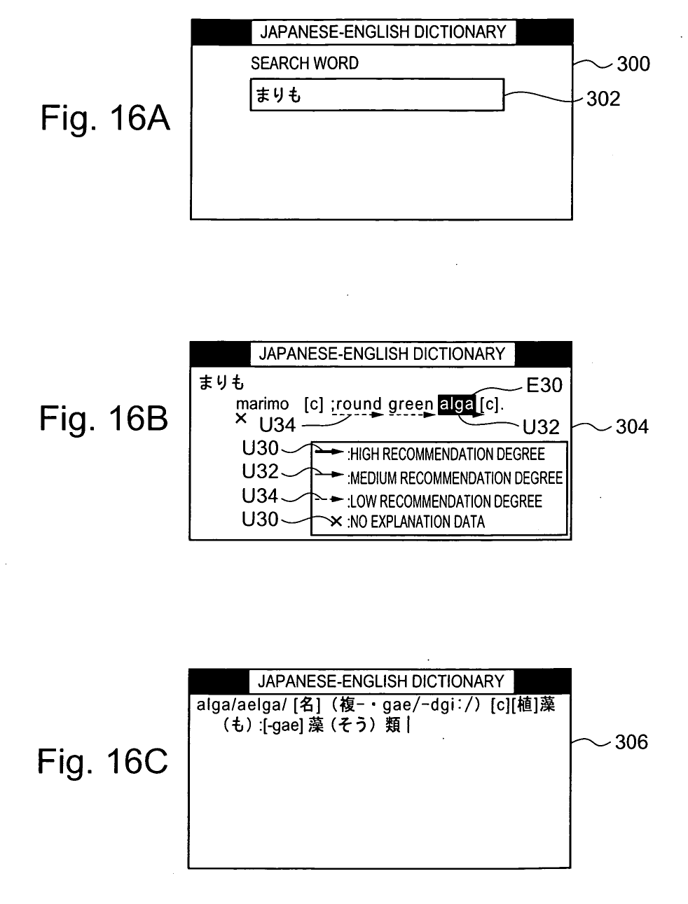

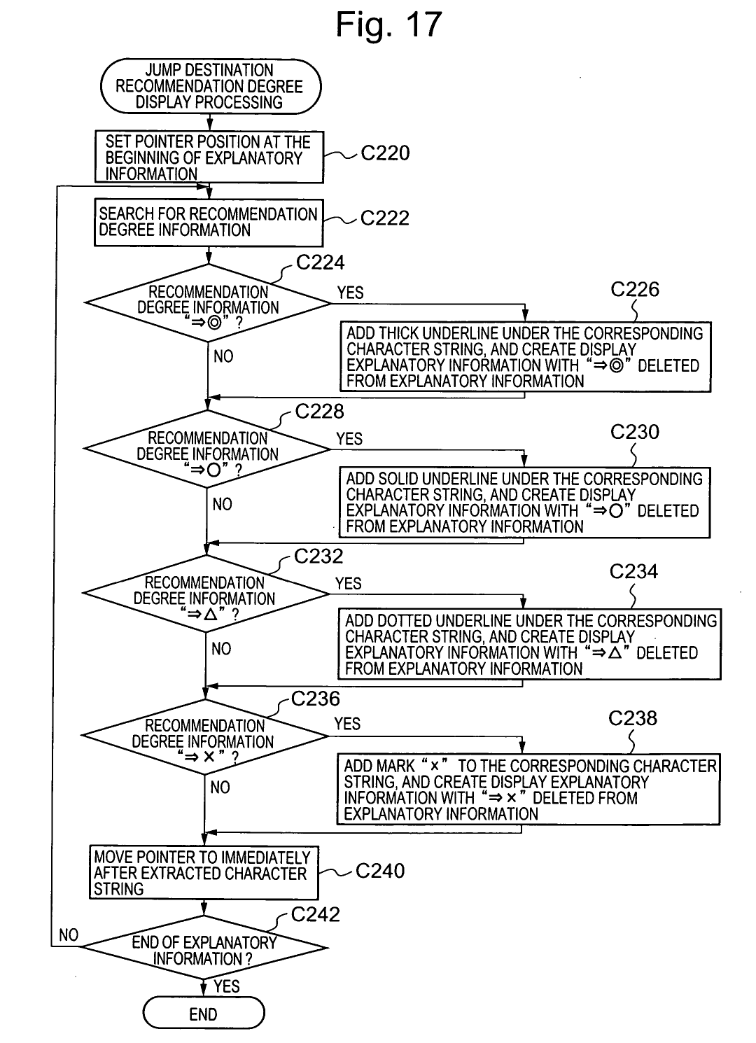

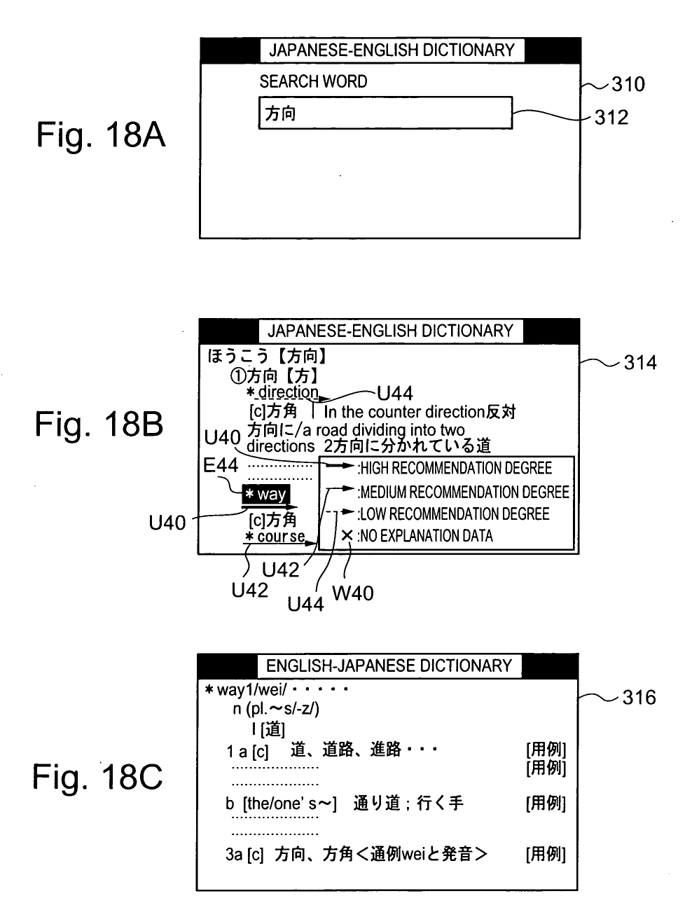

Next, referring to FIGS. 15-18, the operation of the portable electronic dictionary according to the second embodiment of the present invention will be described. FIGS. 15 and 17 indicate the operation flow of the portable electronic dictionary according to the second embodiment, and FIGS. 16A-16C and FIGS. 18A-18C indicate examples of screen transitions displayed on the display section 30.

FIG. 15 is a flowchart of the operation of the portable electronic dictionary according to the second embodiment in relation to the execution of the dictionary search with recommendation degree display processing. As shown in the drawing, when a dictionary designation operation is inputted (step C10), the CPU 10 displays on the display section 30 a search word input screen; the CPU 10 stands by until a search word is inputted (step C12) and a search execution is instructed (step C14).

In response to an input of a search execution instruction, the CPU 10 first sets the designated search word as the entry word and searches for the entry word from among entry words stored in the designated dictionary DB (step C16). Next, the CPU 10 reads explanatory information that corresponds to the entry word searched and displays it on the display section 30 (step C18).

When a jump execution instruction is inputted (step C20), the CPU 10 executes a jump destination recommendation degree display processing (step C22).

FIG. 17 is a flowchart of the operation of the portable electronic dictionary according to the second embodiment in relation to the execution of the jump destination recommendation degree display processing. As shown in the drawing, the CPU 10 first sets the pointer position at the beginning of the explanatory information (step C220). The CPU 10 sequentially scans character strings in the explanatory information from the beginning and searches for the recommendation degree information in the explanatory information (step C222).

If the recommendation degree information 681a “ [symbol] ⊚” is found (step C224: YES), the CPU 10 adds display information to the explanatory information to display a thick underline (i.e., an underline that is thick) under the corresponding character string in the explanatory information, deletes the recommendation degree information 681a “ [symbol] ⊚,” and updates the display dictionary data storage region 82 (step C226).

If the recommendation degree information 681b“ [symbol] ◯” is found (step C228: YES), the CPU 10 adds display information to the explanatory information to display a solid underline (i.e., an underline that is solid) under the corresponding character string in the explanatory information, deletes the recommendation degree information 681b “ [symbol] ◯,” and updates the display dictionary data storage region 82 (step C230).

If the recommendation degree information 681c “ [symbol] Δ” is found (step C232: YES), the CPU 10 adds display information to the explanatory information to display a dotted underline (i.e., an underline that is dotted) under the corresponding character string in the explanatory information, deletes the recommendation degree information 681c “ [symbol] Δ,” and updates the display dictionary data storage region 82 (step C234).

If the recommendation degree information 681d “ [symbol] x” is found (step C236: YES), the CPU 10 adds display information to the explanatory information to display a mark “x” for the corresponding character string in the explanatory information, deletes the recommendation degree information 681d “ [symbol] x,” and updates the display dictionary data storage region 82 (step C238).

The CPU 10 then moves the pointer to immediately after the matching entry word (step C240); if the pointer position is not at the end of the explanatory information (step C242: NO), the CPU 10 returns to step C222 and repeats the processing. If the pointer position is at the end of the explanatory information (step C242: YES), the CPU 10 terminates the processing and transitions to step C24 in FIG. 15.

For example, when the Japanese-English dictionary is designated, when a search word input screen 300 is displayed, and when the Japanese search word (for example, “ [symbol] ” which may typically correspond to an English word “marimo”) is inputted into a search word input box 302, as shown in FIG. 16A, English words in the explanatory information to which jumps can be made are displayed with underlines according to the line type that corresponds to the jump recommendation degree of each in the explanatory information, as shown in FIG. 16B.

For example, in FIG. 16B, “alga” is identifiably displayed with an underline with arrow U32, whose line type indicates a jump recommendation degree of “medium” for the jump destination. The character string “round” is identifiably displayed with an underline with arrow U34, whose line type indicates a jump recommendation degree of “low” for the jump destination. The English word “marimo” is displayed with a mark “x” M30, which indicates that there is no jump destination or explanatory information. And character strings with a jump recommendation degree of “high” for the jump destination are identifiably displayed with an underline with arrow U30 in the corresponding line type.

The CPU 10 accepts an input of a jump destination character string designation operation (step C24) and monitors an input of a termination operation (step C26); if the termination operation is inputted, the CPU 10 terminates the processing.

If the jump destination character string designation operation is inputted (step C24: YES) and a character string displayed with the mark “x” is selected (step C28: YES), the CPU 10 displays on the display section 30 an invalid message for the character string selection operation (step C30), returns to step C24, and stands by for an input of a jump destination character string designation operation.

If a character string other than a character string displayed with the mark “x” is selected (step C28: NO), the CPU 10 sets the designated character string as the entry word (step C32), returns to step C16 to repeat the processing described with the dictionary database corresponding to the entry word set as the designated DB, and searches for and displays the corresponding explanatory information.

For example, in a search result display screen 304 in FIG. 16B, when “alga” is selected and highlighted (E30), a search result display screen 306 of the English-Japanese dictionary is displayed as shown in FIG. 16C, thereby displaying the explanatory information stored in the English-Japanese dictionary DB 66 that corresponds to the entry word “alga.”

FIG. 18 shows another example of screen transition. For example, in a search word input screen 310 shown in FIG. 18A, when a Japanese search word (for example, “ [symbol] ” which may typically correspond to an English word “direction”) is inputted into a search word input box 312 and a search execution is instructed, explanatory information that corresponds to the entry word as the designated character string is displayed, and corresponding English words in the explanatory information to which jumps can be made are displayed with underlines of various line types according to the jump recommendation degree of each English word, as shown in FIG. 18B.

For example, in FIG. 18B, “direction” is identifiably displayed with an underline with arrow U44, whose line type indicates a jump recommendation degree of “low” for the jump destination. The character string “way” is identifiably displayed with an underline with arrow U40, whose line type indicates a jump recommendation degree of “high” for the jump destination. The character string “course” is identifiably displayed with an underline with arrow U42, whose line type indicates a jump recommendation degree of “medium” for the jump destination.

Furthermore, in a search result display screen 314 in FIG. 18B, when “way” is selected and highlighted (E44), a search result display screen 316 of the English-Japanese dictionary is displayed as shown in FIG. 18C, thereby displaying the explanatory information stored in the English-Japanese dictionary DB 66 that corresponds to the entry word “way.”

As described above, according to the second embodiment, of character strings included in explanatory information that is displayed as a result of inputting a search word and instructing a search execution, character strings to which jumps can be made are displayed in various display modes depending on the corresponding jump recommendation degree in the explanatory information.

Although electronic dictionaries and electronic dictionaries that include electronic encyclopedia have been described as application examples according to the embodiments, the present invention is not limited to such products and can be applied to any electronic equipment, including portable telephones, personal computers and electronic watches. Furthermore, electronic dictionary data can be stored on memory cards or CDs that are detachable from the main body of electronic dictionaries.

Although the embodiments were described in situations in which a portable electronic dictionary is connected to the dictionary server 100 via the network N1 to download entry words from the net dictionary DB 102, entry words can also be downloaded from a dictionary DB stored on a CD-ROM that is detachable from a personal computer connected by a cable to the portable electronic dictionary.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information display control device comprising:
at least one information storage unit that stores entry words and explanatory information correlated with each of the entry words;
an entry word designation unit that designates an entry word;
a search unit that searches the at least one information storage unit for explanatory information corresponding to the entry word designated by the entry word designation unit;
an entry word extraction unit that extracts from the at least one information storage unit at least one matching word that matches a part of character strings included in the explanatory information; and
a display control unit that controls display of the explanatory information searched by the search unit and identifiably displays the at least one matching word extracted by the entry word extraction unit.

2. An information display control device according to claim 1, wherein the entry word extraction unit that extracts from the at least one information storage unit a plurality of matching words that match a plurality of parts of character strings included in the explanatory information, respectively.

3. An information display control device according to claim 1, wherein
the at least one information storage unit comprises a plurality of information storage units, each storing entry words and explanatory information correlated with the entry words; and
the entry word extraction unit includes a multiple information extraction unit that extracts from at least one of the plurality of information storage units at least one matching entry word that matches a part of character strings included in the explanatory information searched by the search unit.

4. An information display control device according to claim 3, wherein the display control unit comprises a multiple information display control unit that controls display of the explanatory information searched by the search unit, and identifiably displays the at least one matching word extracted by the entry word extraction unit.

5. An information display control device according to claim 3, wherein the multiple information extraction unit extracts at least one matching entry word from each of two or more of the plurality of information storage units.

6. An information display control device according to claim 5, wherein the display control unit comprises a multiple information display control unit that controls display of the explanatory information searched by the search unit, and identifiably display the at least one matching word extracted from the each of two or more of the plurality of information storage units by the entry word extraction unit.

7. An information display control device according to claim 1, wherein the entry word extraction unit extracts from the at least one information storage unit the at least one matching word without designating the at least one part of character strings included in the explanatory information.

8. An information display control device according to claim 1, wherein the entry word extraction unit sequentially scans the character strings in the explanatory information, extracts the at least one part of the character strings as a word from the explanatory information, and searches the at least one information storage unit for the at least one matching word that matches the word extracted.

9. An information display control device according to claim 1, comprising:
a reception unit that is communicatively connected via a communications network to an information providing device equipped with an external information storage unit that stores entry words and explanatory information correlated with each of the entry words;
an external entry word storage unit that stores the entry words received by the reception unit;
an external entry word extraction unit that extracts from the external entry word storage unit at least one matching word that matches a part of character strings included in the explanatory information searched by the search unit; and
an entry word display control unit that controls display of the explanatory information searched by the search unit and identifiably displays the at least one matching word.

10. An information display control device according to claim 9, wherein the reception unit communicates with the information providing device at a predetermined timing to receive entry words stored in the external information storage unit, and further comprising a unit that updates the entry words stored in the external entry word storage unit with the entry words received.

11. An information display control device comprising:
first and second information storage units, each storing entry words, explanatory information corresponding to each of the entry words and explanation of words included in the explanatory information, wherein the entry words, the explanatory information and the words are correlated with one another;
an entry word designation unit that designates an entry word;
a search unit that searches for explanatory information corresponding to the entry word designated by the entry word designation unit from among the explanatory information stored in the first information storage unit;
a judgment unit that judges whether explanation of at least one word included in the explanatory information searched by the search unit is stored in at least one of the first information storage unit and the second information storage unit;
a first display control unit that performs a display indicating that explanation of the at least one word included in character strings of the explanatory information is searchable in the first information storage unit, when the judgment unit judges that the explanation of the at least one word included in the explanatory information is stored in the first information storage unit; and
a second display control unit that performs a display indicating that explanation of the at least one word included in character strings of the explanatory information is searchable in the second information storage unit, when the judgment unit judges that the explanation of the at least one word included in the explanatory information is stored in the second information storage unit.

12. An information display control device comprising:
a plurality of different information storage units, each storing entry words and explanatory information correlated with each of the entry words, wherein, when the explanatory information includes at least one character string that matches with an entry word stored in at least one of the plurality of information storage units, the explanatory information includes entry word present information correlated with the at least one character string.

13. An information display control device according to claim 12, comprising:
a designation unit that designates one of the plurality of information storage units;
an entry word designation unit that designates an entry word;
a search unit that searches the one of the plurality of information storage units designated by the designation unit for explanatory information corresponding to the entry word designated by the entry word designation unit; and
a display control unit that controls display of the explanatory information searched by the search unit and identifiably displays at least one character string correlated with one of the entry word present information based on the entry word present information corresponding to the explanatory information searched by the search unit.

14. An information display control device according to claim 13, wherein the entry word present information includes a predetermined recommendation degree, and further comprising a unit that controls the display control unit to identifiably display the at least one character string differently depending on the recommendation degree.

15. An information display control device according to claim 14, wherein the recommendation degree is determined according to the amount of data of the explanatory information corresponding to the entry word.

16. An information display control device according to claim 14, wherein the recommendation degree is determined according to the number of example sentences and/or phrases of the explanatory information corresponding to the entry word.

17. A storage medium that stores a program that causes a computer to realize:
an information storing function that stores entry words and explanatory information correlated with each of the entry words;
an entry word designation function that designates an entry word;
a search function that searches from among the explanatory information stored in the information storage function for explanatory information corresponding to the entry word designated by the entry word designation function;
an entry word extraction function that extracts from the information storage function at least one matching word that matches a part of character strings included in the explanatory information searched by the search function; and
a display control function that controls display of the explanatory information searched by the search function and identifiably displays the at least one matching word extracted by the entry word extraction function.

18. A storage medium that stores a program that causes a computer to realize:
first information storage function and second information storage function, each storing entry words, explanatory information corresponding to each of the entry words and explanation of words included in the explanatory information, wherein the entry words, the explanatory information and the words are correlated with one another;
an entry word designation function that designates an entry word;
a search function that searches for explanatory information corresponding to the entry word designated by the entry word designation function from among the explanatory information stored in the first information storage function;
a judgment function that judges whether explanation of at least one word included in the explanatory information searched by the search function is stored in at least one of the first information storage function and the second information storage function;
a first display control function that performs a display indicating that explanation of the at least one word included in character strings of the explanatory information is searchable in the first information storage function, when the judgment function judges that the explanation of the at least one word included in the explanatory information is stored in the first information storage function; and
a second display control function that performs a display indicating that explanation of the at least one word included in character strings of the explanatory information is searchable in the second information storage function, when the judgment function judges that the explanation of the at least one word included in the explanatory information is stored in the second information storage function.

19. A search and display method for a dictionary device having a dictionary that stores entry words and explanatory information correlated with each of the entry words, the search and display method comprising:
a step of designating an entry word;
a step of searching from among the explanatory information stored in the dictionary for explanatory information corresponding to the entry word designated by the step of designating the entry word;
a character string extraction step of extracting from the dictionary at least one matching word that matches a part of character strings included in the explanatory information searched by the search step; and
a display control step of controlling display of the explanatory information searched by the search step and identifiably displays the at least one matching word extracted by the entry word extraction step.

20. A search and display method for a dictionary device having a first dictionary and a second dictionary, each storing entry words, explanatory information corresponding to each of the entry words and explanation of words included in the explanatory information, wherein the entry words, the explanatory information and the words are correlated with one another, the search and display method comprising:
an entry word designation step of designating an entry word;
a search step of searching for explanatory information corresponding to the entry word designated by the entry word designation step from among the explanatory information stored in the first dictionary;
a judgment step of judging whether explanation of at least one word included in the explanatory information searched by the search step is stored in at least one of the first dictionary and the second dictionary;
a first display control step of performing a display indicating that explanation of the at least one word included in character strings of the explanatory information is searchable in the first dictionary, when the judgment step judges that the explanation of the at least one word included in the explanatory information is stored in the first dictionary; and
a second display control step of performing a display indicating that explanation of the at least one word included in character strings of the explanatory information is searchable in the second dictionary, when the judgment step judges that the explanation of the at least one word included in the explanatory information is stored in the second dictionary.
